(19) United States
(12) Patent Application Publication
(10) Pub. No.: US 2020/0343525 A1
(43) Pub. Date: Oct. 29, 2020

(54) Composite Electrodes and Manufacture Thereof

(71) Applicants: University of Maryland, College Park, College Park, MD (US); National Institute of Aerospace, Hampton, VA (US); National Aeronautics and Space Administration, Hampton, VA (US)

(72) Inventors: Liangbing HU, Rockville, MD (US); Dylan KIRSCH, Rockville, MD (US); Steven LACEY, Hampstead, MD (US); Yi LIN, Hampton, VA (US); John W. CONNELL, Hampton, VA (US)

(21) Appl. No.: 16/850,997

(22) Filed: Apr. 16, 2020

Related U.S. Application Data
(60) Provisional application No. 62/834,797, filed on Apr. 16, 2019.

(51) Int. Cl. H01M 4/04; H01M 4/62; H01M 4/583

(52) U.S. Cl. CPC H01M 4/043; H01M 4/583; H01M 4/621; H01M 4/0416

(57) ABSTRACT

Composite material and method of manufacture is provided. The composite material is manufactured by a solventless and binderless dry compression process.

### CROSS-REFERENCE TO RELATED APPLICATIONS

This application is based on U.S. Provisional Patent Application Ser. No. 62/834,797, filed Apr. 16, 2019, which application is incorporated herein by reference in its entirety and to which priority is claimed.

### GOVERNMENT SUPPORT STATEMENT

This invention was made with government support under NNX16AC23A awarded by NASA and EEC1263063 awarded by National Science Foundation. The government has certain rights in the invention.

### BACKGROUND

Despite the rise of green processes, electrodes are consistently manufactured using harsh, wet processing techniques, such as the slurry method. Typically, active battery powder, conductive carbon powder, and insulating inactive binding agent(s) are mixed in a highly toxic and flammable solvent, for example, N-methyl-2-pyrrolidione, NMP), cast onto metallic current collectors and then dried thoroughly. Solvent evaporation and NMP recovery systems are costly industrial processing steps for commercial electrode fabrication and are required to avoid potential environmental pollution, which require additional time and energy the electrode fabrication process. The binding agents that hold the electrode constituents together also can undergo various routes of degradation, both before cell assembly and under working conditions. Ultimately, inactive electrode components are not only parasitic, but can be detrimental to overall cell performance.

The current commercial lithium-ion battery (LIB) electrodes are consistently manufactured through roll-to-roll (R2R) wet processing techniques, known as the slurry method, where the active battery powder, conductive carbon powder, and insulating inactive binding agent(s) are rigorously mixed in a highly toxic and flammable solvent (N-methyl-2-pyrrolidione, NMP), cast onto metallic current collectors, and then dried thoroughly (FIG. 3a). Solvent evaporation (and NMP recovery systems) are costly industrial processing steps for commercial electrode fabrication and are required to avoid potential environmental pollution, which add both additional energy and time inputs into the electrode fabrication process. The additives and current collector, necessary to have a functional slurry electrode, also account for a considerable percentage of the total electrode weight, which limits the active mass loading and thus, the achievable energy density of the cell. The binding agents that hold the electrode constituents together also can undergo degradation from atmospheric moisture during the manufacturing process, ultimately leading to the delamination of the electrode from the current collector, or during cell operation, can lead to unwarranted side reactions. Ultimately, inactive electrode components are not only parasitic, but can be detrimental to overall cell performance.

Previous research on alternative LIB electrode fabrication techniques has identified multiple approaches towards solvent-free composite electrode fabrication. Many of these efforts utilize techniques that are realized with costly, high temperature processes such as pulsed laser and sputter deposition. Dry powder electrostatic spraying of commercial active and inactive LIB electrode constituents directly onto the current collector was also successfully investigated by multiple groups, demonstrating that bulk, solvent-free fabrication processes are indeed possible. With green manufacturing becoming more prominent, the NMP solvent can also be substituted for a less harmful, environmentally benign chemical (i.e. H₂O), although this substitution necessitates the addition of other additives and surfactants to ensure proper solvation and mixing, thereby increasing the inactive component weight. In a similar manner, issues posed by commercial LIB binders (i.e. PVDF) in electrode fabrication can be addressed with a substitution for other binder molecules, however under fabrication and electrochemical testing conditions it does not eliminate side reactions or delamination of the electrode from the current collector. The majority of LIB electrode fabrication without the use of binders utilizes nanostructures most often synthesized on carbon supports, or via electrospraying techniques. The nanostructures again face scalability issues and the electrospraying techniques use harmful solvents to create the precursor dispersion. Although previous investigations have advanced the fabrication methodology, they have yet to pair solvent- and binder-free bulk electrode fabrication for LIB systems.

### SUMMARY OF THE DISCLOSURE

The presently disclosed subject matter relates generally to a binder-free composite material and its method of manufacture. In certain embodiments, the composite material includes electrochemically active components, but does not include binders or solvents. In certain embodiments, the method of producing the composite material similarly does not require the use of binders or solvents. In certain embodiments, the component materials are dry pressed to form the composite. In an example embodiment, the dry pressing may occur in a roll-to-roll manufacturing process, thereby improving the throughput of the method for large-scale manufacturing. Embodiments of the present invention may be suitable for many applications, for example, energy storage devices.

Certain embodiments of the invention may be suitable for dry roll-to-roll manufacturing, thereby increasing production output while also alleviating many cost and environmental concerns associated with conventional wet techniques.

In certain embodiments, the disclosure relates to a method for manufacturing a composite electrode, comprising:
providing a compressible carbon allotrope (such as holey graphene) and at least one active material/powder of a battery, and
dry compressing (or dry pressing) the compressible carbon allotrope and the at least one active material without using binder or solvent.

In certain embodiments, the at least one active material is for a positive electrode or negative electrode.

In certain embodiments, the active material is LFP, LCO, LMO, NMC, or LTO.

In certain embodiments, the active material is commercially available.

In certain embodiments, the active material is an intercalation/insertion compound, conversion compound, or a material that undergoes surface-based reactions.

In certain embodiments, the method may further comprise adding at least one second active material to the composite electrode.

In certain embodiments, the dry compressing (or dry pressing) is operated under a pressure ranging from 1 MPa to 1000 MPa, such as 20 MPa to 500 MPa.

In certain embodiments, the composite electrode is formed on a substrate (such as separators, metal foils) or as a freestanding structure.

In certain embodiments, a mold is used.

In certain embodiments, a mold is not used (e.g. on a current collector for scalable manufacturing purposes (such as roll-to-roll processing).

In certain embodiments, carbon-rich or active material-rich composites is formed.

In certain embodiments, the shape of the compressible carbon allotrope is circular or a quadrilateral.

In certain embodiments, the dry compressing is operated at room temperature.

In certain embodiments, the pressure is applied through a compression system, such as hydraulics or pneumatics.

In certain embodiments, the pressure (i.e. the working period of time for compression) is applied for a period ranging from 1 second to 1 hour, such as seconds to minutes, 1 second, 10 seconds, 10 minutes, 1 second to 10 minutes, 10 seconds to 10 minutes or 10 seconds to 20 minutes.

In certain embodiments, the method further comprises subsequent removing of at least one substrate (such as separator, metal foil) to form a supported or freestanding composite electrode.

In certain embodiments, the method further comprises mixing or laying compressible carbon allotrope and the at least one active material before the step of dry compressing.

In certain embodiments, the disclosure relates to a composite material comprising:
a compressible carbon allotrope, and
at least one active material,
wherein the composite material is manufactured by a dry compression (dry pressing) process.

In certain embodiments, the composite material is formed without the use of solvents or binders during the dry compression process.

In certain embodiments, the at least one active material is active battery powder.

In certain embodiments, the active battery powder may be for a positive electrode or negative electrode.

In certain embodiments, the at least one active material is an intercalation/insertion compound, conversion compound, or a material that undergoes surface-based reactions.

In certain embodiments, the composite material comprising additional materials.

In certain embodiments, the composite is formed by dry compression (or dry pressing).

In certain embodiments, the dry compression is operated under a pressure ranging from 1 MPa to 1000 MPa, such as 20 MPa to 500 MPa.

In certain embodiments, the composite material is formed on a substrate, for example, a separator or a metal foil.

In certain embodiments, the composite material is formed as a freestanding structure.

In certain embodiments, the composite material is formed using a mold or without using a mold for scalable manufacturing purposes, for example, roll-to-roll processing.

In certain embodiments, the composite material is formed with a carbon-rich or active material-rich composition.

In certain embodiments, the dry compression is operated at room temperature.

In certain embodiments, the pressure for dry compression is applied through a compression system, such as hydraulics, pneumatics.

In certain embodiments, the pressure is applied for a period ranging from 1 second to 1 hour, such as seconds to minutes.

In certain embodiments, the disclosure relates to an energy storage device comprising the above-mentioned composite material.

In certain embodiments, the disclosure relates to a positive or negative electrode comprising the above-mentioned electrode material.

### BRIEF DESCRIPTION OF THE DRAWINGS

The patent or application file contains at least one drawing/photograph executed in color. Copies of this patent or patent application publication with color drawing(s) will be provided by the Office upon request and payment of the necessary fee.

FIG. 1. Schematic demonstration of the working principle of the solventless, binderless electrode fabrication technique enabled by a compressible carbon allotrope, in this case hG. By facilitating the escape of trapped gases through the pores under compression, stable composite films containing compressible carbon allotropes and incompressible active materials are able to be fabricated into robust structures with the application of hydraulic pressures as low as 20 MPa.

FIG. 2. Schematic demonstration of an example embodiment, the DR2R manufacturing method. This technique has the potential to solve many of the issues associated with conventional wet processing of composite battery electrodes. Utilization of a compressible carbon allotrope as the compressible and conductive matrix for an incompressible active powder allows for binder and solvent free electrode synthesis, alleviating many cost and environmental concerns associated with conventional wet techniques.

FIGS. 3a-3b. (a) Overview of the slurry electrode fabrication technique, which requires the use of binders, conductive additives, hazardous solvents and post-fabrication energy and time inputs to create a uniform cast film. (b) Illustration of the dry compression process for LIB electrode fabrication, which utilizes a combination of a nanoporous carbon (holey Graphene or hG) and battery active material to create binderless, solventless electrodes at room temperature using only hydraulic pressure.

FIGS. 4a-4f. (a) Digital image of the hG powder produced in scalable (gram level) batch sizes. (b) TEM image of a hG flake, showing the nanosized through-thickness holes. (c) Dry processing technique, where hG and LFP powders are mixed and loaded into the pressing die. After application of the desired hydraulic pressure, one or both of the separator/foil discs are easily removed to obtain composite LIB electrodes with or without a current collector. (d) Digital image of a hG:LFP electrode fabricated at 20 MPa, which is a scalable R2R pressing pressure. (e) XRD spectra of a hG:LFP electrode fabricated at 500 MPa (green) and the commercial LFP powder (black), where no peak shifts between the reference LFP Triphylite phase (blue) and Graphite (red) spectra are observed. (f) Raman spectra of a 500 MPa hG:LFP electrode (green) and hG powder (black), showing similar ID/IG ratios before and after pressing.

FIGS. 5a-5n. (a,e,i) Top-view and (b,f,j) SEM cross-sections for freestanding hG:LFP cathode pressed at 500 (top row), 200 (middle row), and 20 MPa (bottom row) for 10 min. (c,g,k) EDS overlays of each pressed hG:LFP composite cathode with (d,h,l) individual elemental maps for carbon (blue), oxygen (red), phosphorus (green), and iron (yellow), respectively. (m) Voltage profiles up to cycle 200 for the hG:LFP cathode pressed at 20 MPa. (n) Rate performance of the dry pressed hG:LFP cathode pressed at 20 MPa for only 10 seconds showcasing that electrodes fabricated with scalable processing parameters can achieve similar capacities at C-rates between 0.2 C and 3 C regardless of hydraulic pressure or pressing time.

FIGS. 6a-6m. (a,d,g,j) SEM cross-sections for freestanding composite electrodes pressed at 500 MPa to prove universality for the dry pressing process. (b,e,h,k) EDS overlays of each pressed LFP:hG composite cathode with (c,f,i,l) individual elemental maps corresponding to the respective constituent elements for LCO (top row), LMO (second row), NMC (third row), and LTO (bottom row). The total electrode mass loadings were all 11.6 mg/cm2. (m) Schematic showcasing a future perspective of the proposed dry press method in order to fabricate composite LIB electrodes in a similar manner to conventional R2R battery manufacturing.

FIGS. 7a-7b. TEM images of the micron-sized flakes of the G powder.

FIG. 8. Zoom-in TEM image of the hG flakes showing the through-thickness holes.

FIGS. 9a-9b. SEM images of the commercial (carbon-coated) LFP powder with characteristic particle diameters on the order of tens to hundreds of nanometers.

FIGS. 10a-10b. SEM images of the mixed hG and LFP powders at different magnifications showing LFP uniformly distributed on the hG flake surface.

FIG. 11. Digital image of dry pressed electrodes fabricated at 500 MPa using commercial LFP powder combined with (left) compressible, nanoporous hG and (right) the precursor G powder in a 1:1 weight ratio.

FIGS. 12a-12g. (a) Digital image showing the setup for the dry pressed electrode drop test, where the electrodes are dropped from a height of approximately 20 cm. Digital images of electrodes fabricated at (b) 500 MPa and (c) 20 MPa using the standard 10 minute pressing as well as (d) 20 MPa using a high-throughput pressing time of 1 second. Each electrode exhibits no visible or measurable weight loss following impact. Bend tests for the respective electrodes, which show identical brittle fracture characteristics: (e) 500 MPa [10 minute pressing], (f) 20 MPa [10 minute pressing], and (g) 20 MPa [1 second pressing].

FIGS. 13a-13c. (a) Voltage profiles up to cycle 50 for a hG:LFP cathode pressed at 500 MPa cycled at 0.2 C. (b) Rate performance of the dry pressed hG:LFP cathodes pressed at 200 (red and black squares) and 500 MPa (green and black triangles) from 0.2 C to 10 C. (c) 2 C cycling performance of a 500 MPa hG:LFP cathode.

FIGS. 14a-14b. (a, b) Digital images of a disassembled half-cell containing a hG:LFP cathode fabricated using the lower pressing limit of 20 MPa. Notably, the dry pressed electrode maintains its robustness even after electrolyte wetting and electrochemical cycling.

FIGS. 15a-15h. SEM images of each commercial LIB active material: (a,b) LCO, (c,d) LMO, (e,f) NMC, (g,h) LTO, respectively.

FIG. 16. Cross-section EDS maps for carbon (blue) and oxygen (oxygen) for the NMC:hG composite electrode fabricated at 500 MPa.

FIGS. 17a-17d. Top-view SEM images of dry processed composite electrodes with hG and (a) LCO, (b) LMO, (c) NMC, or (d) LTO powder, respectively, exhibiting homogeneous distribution of active material throughout.

FIGS. 18a-18d. XRD patterns of composite LIB electrodes with (a) LCO, (b) LMO, (c) NMC, and (d) LTO, respectively. No structural changes are induced after pressing each LIB electrode at 500 MPa.

### DETAILED DESCRIPTION OF EMBODIMENTS

To address the multitude of issues that accompany wet electrode fabrication techniques, composite lithium-ion battery (LIB) electrodes composed of solely active components (active battery material and conductive additive) are fabricated using a scalable and eco-friendly dry processing method known as dry pressing. To accomplish this, a nanoporous carbon allotrope, referred to herein as holey Graphene or hG, acts as the compressible and conductive matrix to accommodate incompressible cathode and anode battery powders. The inherent nanoporosity facilitates the escape of trapped gases upon compression, enabling the formation of binderless and solventless composite electrodes regardless of active battery powder, fabrication pressure, or pressing time. Dry pressed LIB electrodes fabricated with different processing parameters (e.g. hydraulic pressure, pressing time) are evaluated structurally and electrochemically using a model cathode material (lithium iron phosphate) in order to demonstrate the potential of dry pressing as a viable LIB electrode manufacturing method.

The present disclosure relates generally to a binder-free composite battery electrode material and a method of fabrication where electrochemically active components, such as positive or negative electrode material and conductive carbon, are employed without the need for time-consuming high-temperature drying steps, binders, solvents or other inactive materials or additives. Due to the incompressibility of active battery powders, a compressible yet conductive material is used to mold active components into a mechanically robust battery electrode.

The proposed room temperature electrode manufacturing process eliminates the use of the aforementioned inactive components through a dry and additive-free technique, which utilizes a compressible and nanoporous carbon allotrope, referred to herein as holey Graphene or hG. The through-thickness nanoholes on the hG flakes allow trapped gas molecules to escape, allowing for compression into mechanically stable structures. Current findings demonstrate that hG can simultaneously act as the compressible and conductive matrix to accommodate incompressible positive and negative electrode powders to form binderless and solventless composite “dry pressed” electrodes independent of active battery powder, fabrication pressure, or pressing time.

To create a solventless and binderless dry pressed electrode, the active battery material and compressible carbon allotrope (such as hG powder) are homogenously mixed in the desired ratio (i.e. amount of compressible carbon material to amount of active material). Next, the powder mixture is loaded into the stainless-steel pressing die and pressed at a predetermined pressure between two foils, separators, or other substrates. If only one cutout is removed, then the remaining foil can serve directly as the electrode current collector, while a freestanding electrode is achievable if both are removed. Mechanically robust hG-based composite electrode formation using a pressure application of 20 MPa for a duration of only ones to tens of seconds indicates that scalable, high-throughput manufacturing is achievable; it must be noted that electrode synthesis is equally successful and feasible with applied pressures up to 500 MPa, as well as with pressure application durations up to ones to tens of minutes. Electrochemical characterization using a commercial lithium-ion battery active material (lithium iron phosphate, [LFP]) further strengthens this method and reaveals that, in this case, the hG acts as both the compressible and conductive matrix for the active powders to facilitate electron and lithium-ion transport. However, the aforementioned method is not likely limited to the use of hG as the compressible matrix material: additional compressible carbon allotropes with inherent porosity (on the nanoscale/mesoscale) and/or with porosity induced by post-processing steps can be employed towards the fabrication composite electrodes without the use of solvents or binders when combined with the desired active battery material/powder. Additionally, stable structures can be still be fabricated with ease if the incompressible active material is layered sequentially with the compressible carbon allotrope.

We have also envisioned a roll-to-roll (R2R) assembly line inspired fabrication schematic that operates on the same fundamental concept as the laboratory-scale die-pressed electrodes, thusly called “dry” roll-to-roll (DR2R) manufacturing. From an industrial perspective, the dry powder constituents can be easily mixed in large batches and dispensed into either a preset mold on a conveyer belt or onto the desired current collector; hydraulic pressure can then be applied directly to this loose powder mixture coated current collector by rollers analogous to those in use in R2R applications at comparable pressures (20 MPa). Following compression, the resulting dry processed carbon allotrope-based electrode sheet can be used directly with the current collector in industrial cell manufacturing. In a similar manner, said electrode film can be turned into a freestanding structure by removing the current collector and subsequently used in the next step of industrial cell fabrication.

The DR2R manufacturing method addresses the major material, processing, and financial challenges facing battery processing. Binderless and solventless composite electrodes remove the need for problematic solvents, binders, and additives that are generally necessary to form stable structures for electrochemical energy storage applications. The dry processed (laboratory-scale or DR2R) electrodes formed at room temperature with scalable parameters will allow for cheaper, safer, and more environmentally conscious electrode fabrication techniques.

### EXAMPLES

The following describes example embodiments and uses of the presently described composite material and method of manufacture. Specific example embodiments are described herein to demonstrate the performance of the material and method in example applications as battery electrodes. The presently described material and method of fabrication may be used in other applications and should not be limited to the example embodiments presented hereafter.

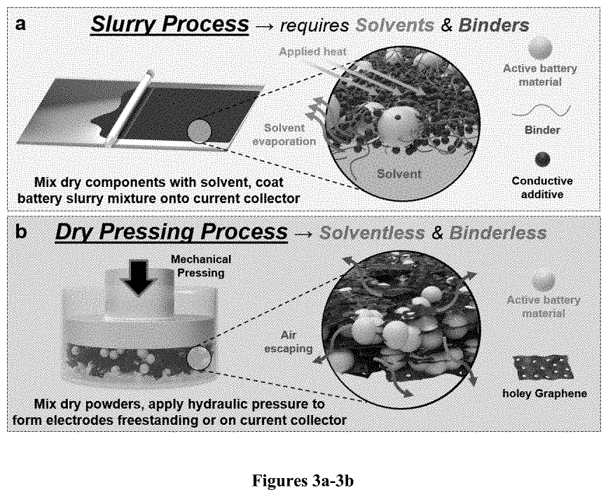

Disclosed herein is an exemplary fabrication method (i.e. dry/cold pressing or compression molding) for manufacturing composite electrodes, where only electrochemically active components (cathode/anode material and conductive carbon) are employed without the use of time-consuming high-temperature drying steps, as well as binders, solvents or other inactive materials/additives (FIG. 3b). Due to the incompressibility of active battery powders, a compressible yet conductive material is required to compression mold active components into a mechanically robust battery electrode. Herein, active LIB materials are dry mixed with hG and cold pressed into freestanding composite LIB electrodes to evaluate the universality and scalability of this dry processing technique while more in-depth structural and electrochemical evaluations are undertaken using a model cathode material (lithium iron phosphate, LFP).

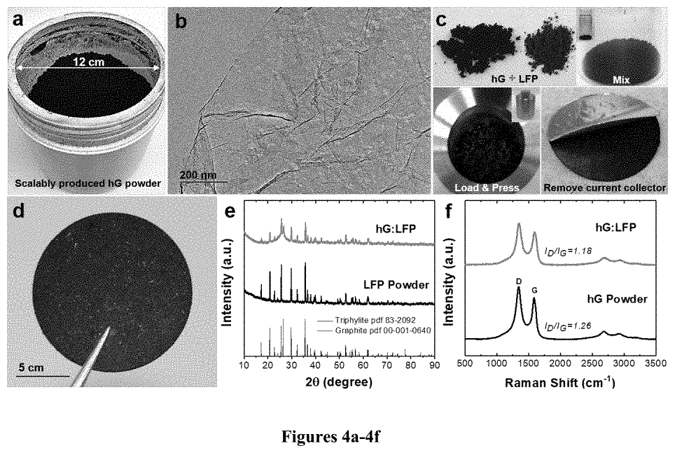

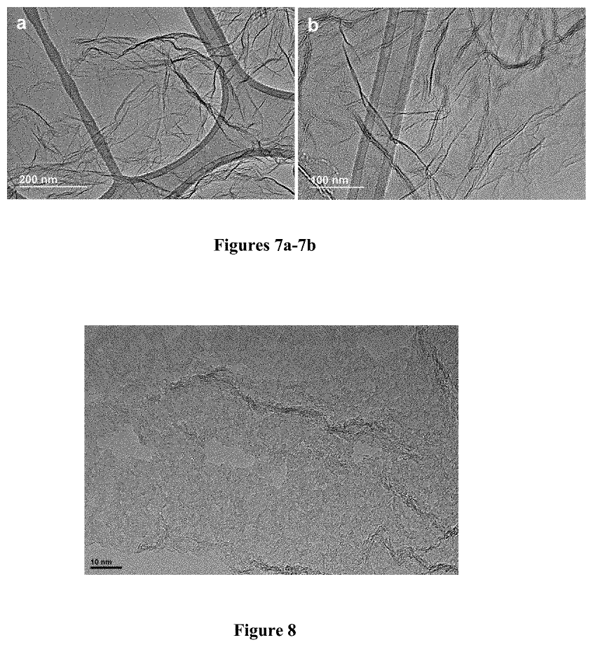

hG powder is prepared through a facile heat treatment procedure in an open-ended tube furnace, where through-plane nanoholes can be obtained from the nonporous commercial graphene precursor (henceforth referenced to as G). FIG. 4a shows a digital image of the facilely produced hG powder in scalable batch sizes. Transmission electron microscopy (TEM) was used to elucidate the flake (and hole) dimensions of the precursor G powder (FIGS. 7a and 7b) and hG (FIG. 4b and FIG. 8). The characteristic TEM images of the intact G powder indicate the absence of holes on the flake surface, while the nanosized through-holes decorating the hG flakes induce a unique property that conventional carbon materials do not possess: compressibility. According to our labs previous findings, the through-thickness nanoholes on the hG flakes allow trapped gas molecules to escape. With strong interactions between adjacent sheets due to the abundant hole-edge carbons, compression of the hG flakes into robust, compact, shape retaining monolithic architectures is enabled. Presently, all previous dry pressed hG-based architectures, demonstrated as supercapacitor and lithium-oxygen (Li—O2) battery electrodes, were entirely carbon-based (i.e. hG or [incompressible] catalyst-loaded hG powders). As such, to evaluate the ability of hG to form mechanically stable composite electrode structures with other incompressible non-carbon materials, an array of active LIB powders are combined with hG powder in a set weight ratio (i.e. 1:1), and subsequently compressed. A brief digital montage of the dry pressing process is shown in FIG. 4c, where the dry powders are mixed, loaded into the die, and subsequently pressed in order to form freestanding or current collector-based electrodes after removal of the separator/foil discs. Note that LFP was chosen as the model active powder since it is a well-studied LIB cathode material known for its high-power capability, high thermal stability and flat voltage plateau at 3.4 V vs Li/Li+. FIGS. 9a and 9b are SEM images of the as-received carbon-coated LFP powder (particle diameter: 10-100's of nanometers) used for dry mixing and LIB electrode fabrication.

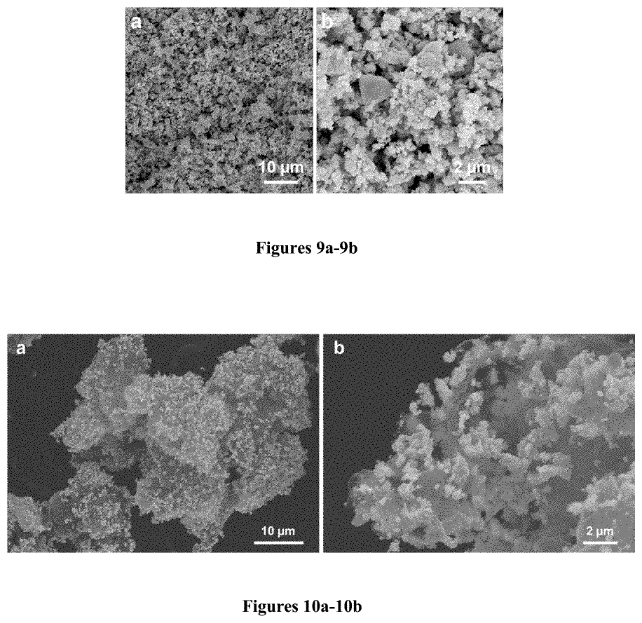

To create a solventless and binderless dry pressed electrode, the active battery material (i.e. LFP) and the desired graphene powder must be uniformly mixed in a set weight ratio (e.g., 1:1) using a benchtop mixer. Next, the powder mixture is loaded into the stainless-steel pressing die and pressed at a predetermined pressure (20-500 MPa) between two Al-foil cutouts/separators to prevent adhesion to the die surface. If only one Al-foil cutout is removed, then the remaining foil can serve directly as the cathode current collector; however, in this work, we chose to demonstrate the ability to form freestanding hG-based composite LIB electrodes. Each graphene material was mixed with LFP powder in the same 1:1 ratio (G:LFP and hG:LFP) and pressed at the upper hydraulic pressure limit of 500 MPa to compare the material's ability to form a mechanically stable composite electrode (FIG. 10). By inspection, powders begin to break off from the G:LFP cathode during foil removal and subsequent handling, which is problematic for cell assembly. However, the hG:LFP cathode can be handled with ease without material loss. Note that the robustness of the hG:LFP cathode is again attributed to the inherent nanoporosity of the hG powder, where the hG flakes act as both the “compressible matrix” and “conductive additive” within the pressed electrode. Accordingly, all composite electrodes reported hereafter are composed of the nanoporous carbon allotrope: hG.

To investigate whether hG-based composites can be fabricated at low hydraulic pressures, a hG:LFP composite electrode was pressed at 20 MPa (FIG. 4d). Note that 20 MPa matches the applied pressure for scalable R2R manufacturing, which is on the low-pressure limit for conventional hydraulic presses. Remarkably, a 1:1 hG:LFP cathode can be successfully fabricated and is mechanically robust even at this low processing pressure. At the other end of the pressure spectrum, structural changes of the dry material components may occur due to the applied pressure. To verify or deny this hypothesis, composite hG:LFP cathodes pressed at 500 MPa were characterized via several spectroscopy techniques. FIG. 4e shows an XRD pattern for the hG:LFP composite electrode in reference to the as-received commercial LFP powder and crystalline triphylite phase (PDF 83-2092). The uncompressed LFP powder and composite electrode spectra match very well, with negligible peak shifts, proving no structural changes are induced in LFP even after being subjected to 500 MPa. Accordingly, it must follow that no structural changes will be induced at lower applied pressures (<500 MPa). Note that the broad peak at approximately 26° corresponds to some graphitic carbon regions (PDF 00-001-0640) present within the hG powder, which is typical for few-layered graphene materials. Raman spectroscopy can be used to qualitatively probe whether there is a significant change in disorder (i.e. D and G peak intensity ratio or ID/IG) in the hG sheets before and after the application of 500 MPa of pressure. The ID/IG values for the uncompressed hG powder and the composite cathode are nearly identical (1.26 vs 1.18), which confirms that the dry processing technique does not alter the compressible matrix material (hG) (FIG. 4f). Based on the results of XRD and Raman spectroscopy, the dry pressing process does not induce structural changes in either pressing material (LFP or hG).

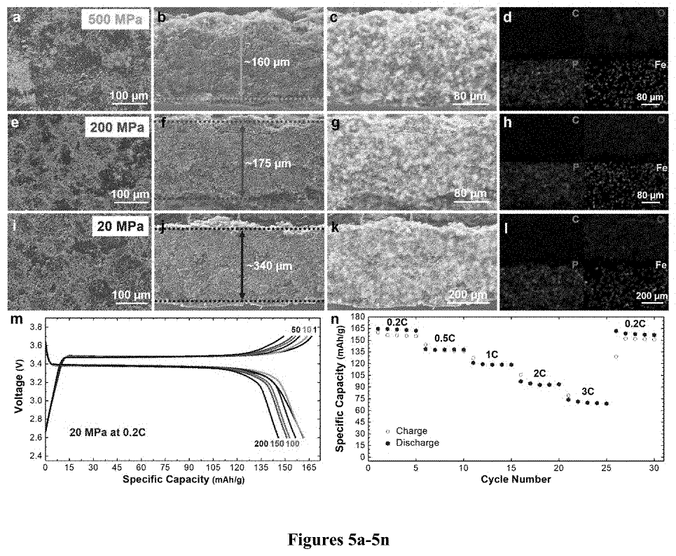

To investigate the spatial distribution of pressing material components and the effect of hydraulic pressure on overall electrode morphology, composite hG:LFP cathodes (1:1, 11.6 mg/cm2 total loading) were fabricated at three different hydraulic pressures (20, 200, and 500 MPa) and studied using microscopy and elemental mapping techniques. FIG. 5 shows top view and cross-section SEM images with corresponding cross-section EDS maps for electrodes fabricated at each applied pressure. The top view images (FIG. 5a,e,i) for all pressed electrodes show similarly uniform distributions of LFP and hG independent of applied pressure, which is expected due to the homogeneous dry powder mixing step. The electrode cross-sections also exhibit comparable morphologies, where electrode thickness increases with decreasing hydraulic pressure (FIGS. 5b,f,j). Specifically, at the same mass loading (11.6 mg/cm2), the 20 MPa cathode is ultrathick (approximately 340 μm) and approximately twice the thickness of the 200 MPa (approximately 175 μm) and 500 MPa cathodes (approximately 160 μm). To probe the homogeneity and elemental distribution of the pressed electrode structure, EDS was performed on each of the cross-sections (FIG. 5c,g,k). The EDS overlay maps indicate that LFP is homogeneously distributed throughout the entire thickness of the electrode regardless of applied pressure. The corresponding individual elemental maps (FIG. 5d,h,l) provide a similar perspective on elemental distribution, where blue, red, green, and yellow represent carbon (C), oxygen (O), phosphorous (P), and iron (Fe), respectively. Similar to conventional slurry-based processing, it is evident that the proposed dry/cold pressing electrode fabrication method also enables uniform material distributions throughout the entire electrode thickness, which is advantageous for electrochemical performance.

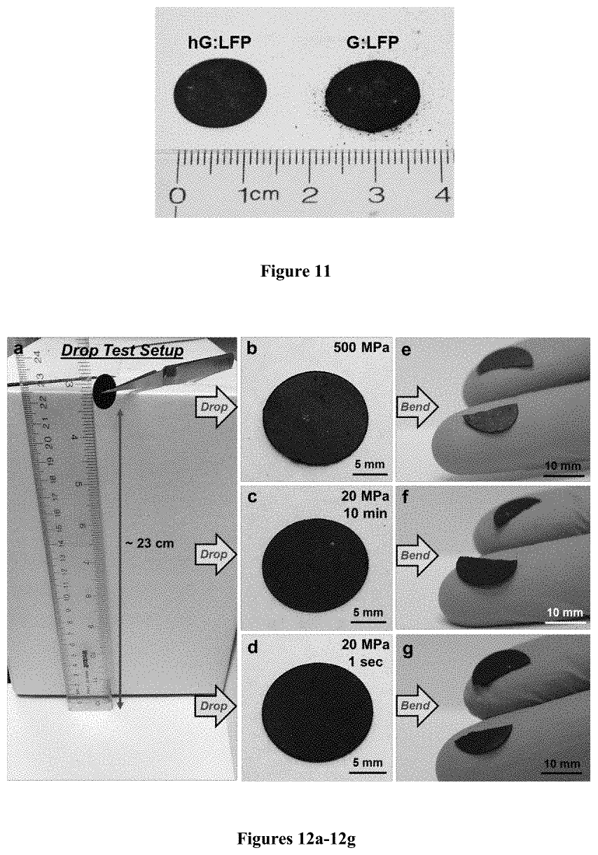

To evaluate the dry pressed hG:LFP electrodes electrochemically, CR2032 cells were assembled in a half-cell configuration and tested with a typical LIB electrolyte (see Experimental Methods section for details). hG:LFP electrodes pressed at the two pressure extremes (20 and 500 MPa) are subjected to galvanostatic cycling (GC) in a set voltage window (2.6-3.7 V) at a C-rate of 0.2 C. FIG. 5m and FIG. 11a show the associated charge-discharge characteristics for dry pressed hG:LFP cathodes fabricated at 20 and 500 MPa, respectively. As expected, both cells exhibit the characteristic LFP voltage plateau (approximately 3.4V) over all cycles. Notably, both dry pressed hG:LFP cathode cells show similar capacity retention within experimental error and reach >160 mAh/g for at least the first 10 cycles. To investigate further, the rate capabilities of the dry pressed hG:LFP electrodes were probed using rate dependent cycling tests with electrodes prepared using 500 and 200 MPa (FIG. 11b). The applied C-rate was increased sequentially every 5 cycles from 0.2 C, to 3 C and then returned to 0.2 C. The rate capabilities of the 500 and 200 MPa dry pressed cathodes matched closely with the previous GC results, indicating an independence between the composite electrode fabrication pressure and the associated electrochemical performance.

To this point, all dry pressed electrodes were fabricated via an applied pressure (20, 200 or 500 MPa) for a duration of 10 minutes. To further illustrate the scalable processing parameters achievable using the hG-enabled dry pressing process, hG:LFP cathodes are fabricated using an applied pressure of 20 MPa for a mere 10 seconds for electrochemical testing. The rate dependent cycling tests for the 20 MPa 10 second cathode shown in FIG. 5n exhibit similar metrics to the hG:LFP electrodes fabricated at 20, 200 and 500 MPa for 10 minutes, illustrating the true scalable nature of the hG-based solventless, binderless electrodes. Extended high rate (2 C) cycling of a hG:LFP cathode fabricated with an applied pressure of 500 MPa (FIG. 11c) also reaches similar specific capacity values in regards to the rate-dependent cycling of the 500 MPa electrode, highlighting the mechanical and electrochemical stability of LIB electrodes fabricated via the proposed dry/cold pressing process.

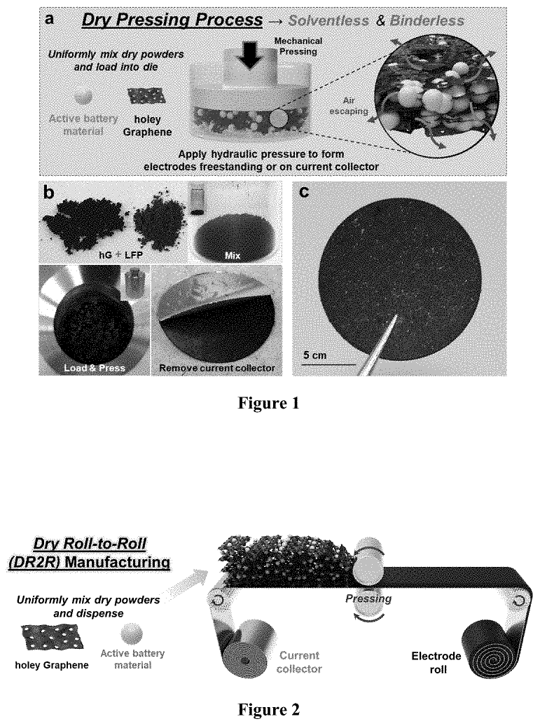

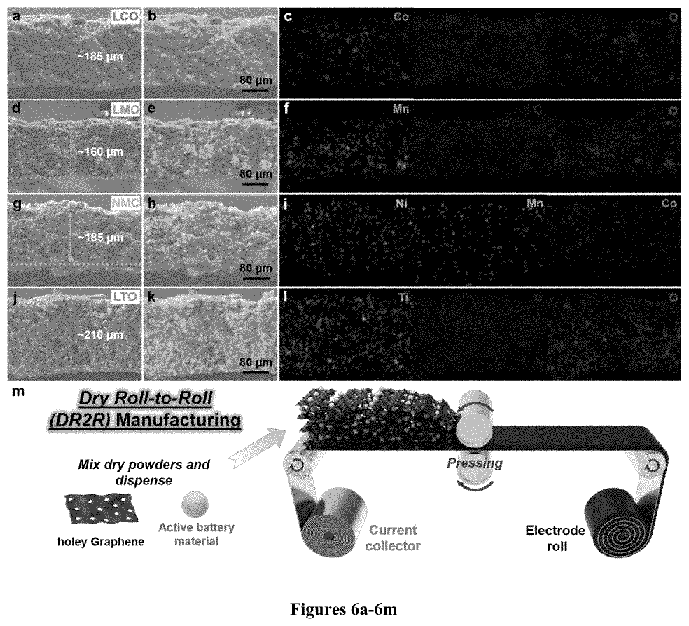

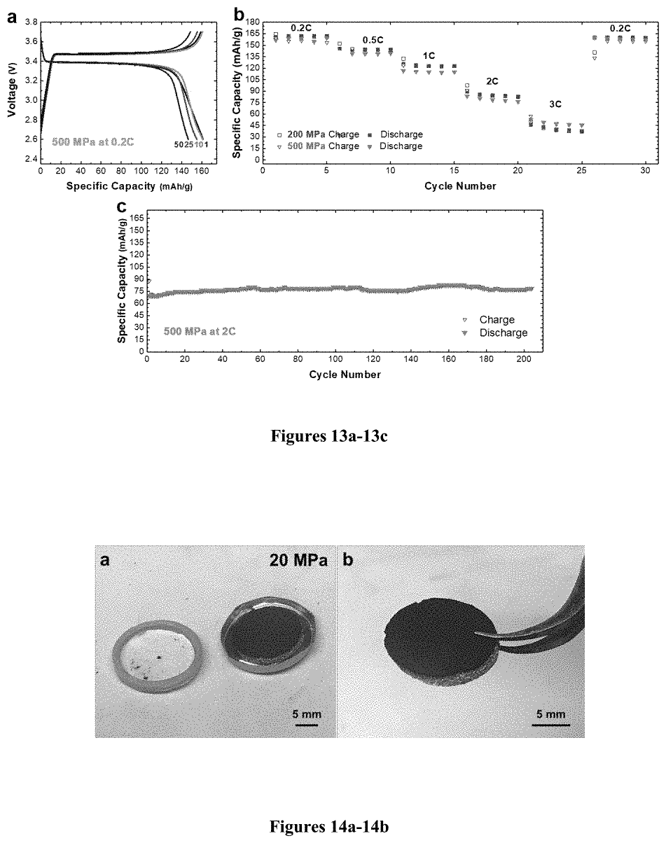

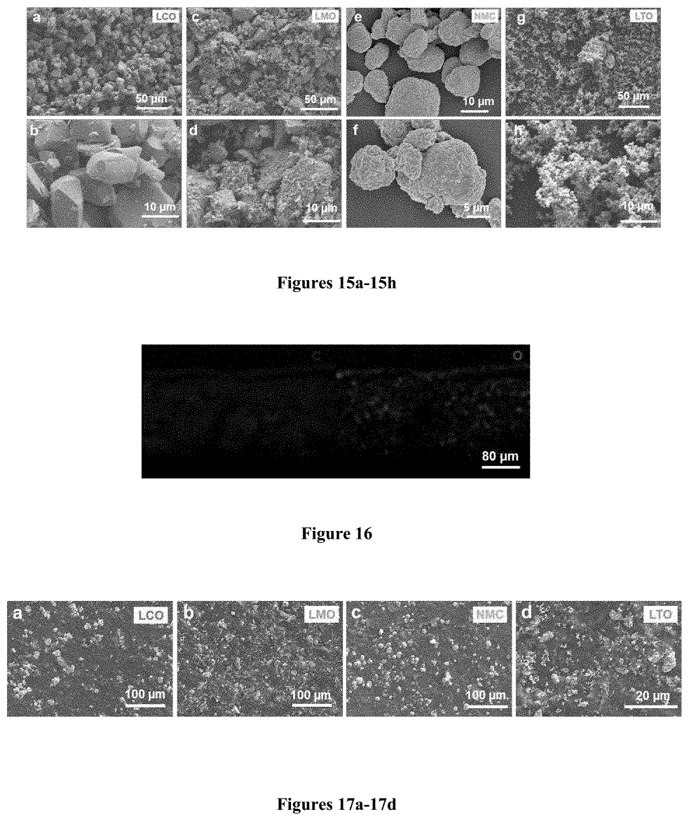

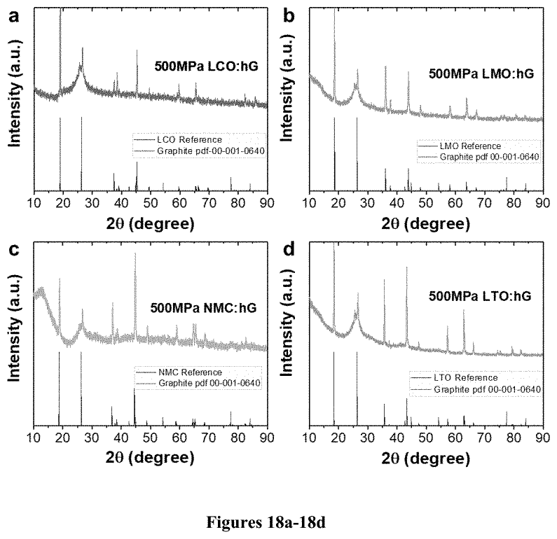

To be a viable LIB electrode fabrication technique, the dry pressing process must possess the ability to form mechanically robust structures with any active battery material (cathode or anode) without inducing structural changes. To demonstrate the universality of the dry pressing method, electrodes were fabricated at 500 MPa using numerous commercial active battery powders: LiCoO2 (LCO), LiNiMnCoO2 (NMC), LiMn2O4 (LMO), and Li4Ti5O12 (LTO). Typical powder morphologies for each commercial active material are once again elucidated via SEM (FIG. 12), showing characteristic particle diameters typically in the microscale regime. To fabricate the composite cathodes or anodes, the respective active powder was combined with compressible hG using the same dry press method in a set 1:1 weight ratio and mass loading (11.6 mg/cm2). Parallel to the dry pressed hG:LFP cathode, each universal composite pressed at 500 MPa shows similar morphological features and a uniform elemental distribution throughout the entire electrode thickness, as shown by the microscopy and individual elemental maps (FIG. 6a-1, FIG. 13). Corresponding top view SEM images show a similar homogeneous distribution of active material particles (FIG. 14). Even though the particle size among these various active LIB components differs, mechanically robust composite electrodes can be readily fabricated using the same dry pressing process enabled by hG. Similar to the model hG:LFP cathodes, to prove that no structural changes occurred upon compression up to 500 MPa, XRD patterns were collected for each universal electrode (FIG. 15). In comparison to the respective reference peaks, the XRD spectra collected from each universal composite electrode indicates no structural changes of the active battery powders upon dry pressing. Therefore, this additive-free, room temperature dry processing technique shows no foreseeable limitations in terms of cathode and anode materials and can likely be adopted for next generation active materials in order to create mechanically robust electrodes for advanced LIBs and beyond.

FIG. 6m is a schematic representation of an assembly line-inspired version of the proposed dry press method, dubbed dry roll-to-roll (DR2R) manufacturing, towards large-scale LIB electrode manufacturing. From an industrial processing perspective, the dry powder constituents can be easily mixed in large batches and dispensed into either a preset mold on a conveyer belt or onto the desired current collector. Analogous to conventional R2R manufacturing, rollers can apply hydraulic pressure to the initial loose powder mixture on the underlying current collector to produce mechanically robust electrodes using similar pressures (20 MPa) to those already used for scalable electrode fabrication. After compression, the resultant hG:active battery powder sheet can be used directly with the current collector or be removed to form freestanding electrodes for industrial cell manufacturing.

Summary of Results

In summary, a scalable dry processing technique (i.e. dry/cold pressing) was successfully employed to fabricate composite electrodes using compressible hG and conventional battery active materials (LFP, NMC, LCO, LMO, LTO) without the use of binders, solvents or other additives at room temperature. Compared to conventional wet processing (i.e. slurry method), this dry processing technique is advantageous in terms of material requirements (even current collectors are not necessary), eco-friendliness (no toxic solvents such as NMP), and overall cost of LIB production, especially in terms of the required energy and time input (no extensive solvent removal/recovery steps during industrial processing) since pressing occurs at room temperature. Regardless of the active material or the applied hydraulic pressure (20-500 MPa), the pressed, freestanding hG-based structures were homogenously mixed and underwent no structural changes of either material component, as confirmed by microscopic, spectroscopic, and diffraction techniques. As an example embodiment, LFP was used as a model cathode active material, dry pressed hG:LFP cathodes were characterized electrochemically via GC and rate tests, where characteristic LFP voltage profiles and reversible capacities were demonstrated without dependence on hydraulic pressure or the pressing time. Implementations of the present method may enable DR2R electrode manufacturing using this universal binder-free processing technique. In commercial scale production, the present method may be employed in the form of DR2R manufacturing such that scalable batch sizes of the chosen active LIB material and the nanoporous hG powder would be homogeneously mixed in the desired weight ratio, dispensed onto a conveyor belt, and subsequently pressed at a specific hydraulic pressure to achieve composite LIB electrodes with controlled thickness at high throughput. The described method may also be suitable for use with other advanced battery active materials, beyond LIB applications, or other potentially compressible carbons. Such implementations of the method may be useful for dry, large-scale, environmentally-friendly electrode production, among other applications.

Experimental Methods

Material Synthesis and Composite Electrode Fabrication of an Example Embodiment of the Invention

hG is fabricated using a previously reported method that utilizes a facile, one-step, catalyst/chemical-free procedure. In a typical procedure, a quartz boat containing 1.5 g graphene powder (Vorbeck Materials, Vor-X reduced 070; lot: BK-77x) is placed in an open-ended tube furnace (MTI Corporation; Model OTF-1200X-80-II), ramped to 430° C. at 10° C./min and then held at that temperature for 10 hours. hG powder was subsequently obtained with a typical yield of 70-80%. All active LIB cathode materials, including LFP, LCO, LMO, and NMC, were purchased from MTI Corporation. The anode active material LTO was purchased from Aldrich Chemical Co. To fabricate the composite electrodes using the dry/cold pressing process, hG and electrode active material powders must first be uniformly mixed. This is done by adding equal amounts of each constituent into a vial and mixing using a Benchmark Scientific Inc. BV1000 Vortex Mixer for approximately 60 seconds. A vortex mixer is preferred over ball milling to retain the inherent compressibility of the hG powder. The powder mixture is then added directly into a 15 mm stainless-steel die between two aluminum (Al)-foil cutouts to prevent adherence to the die. Using a Carver hydraulic press unit (model #3912), the assembled die is subjected to the desired pressure for 10 minutes, unless stated otherwise. Following the application of the hydraulic pressure, the composite electrode is removed from the Al-foil cutouts and used directly for the next step in LIB cell assembly.

Material Characterization

A Horiba Jobin Yvon LabRam ARAMIS Raman spectrometer with a 532 nm excitation source was employed to obtain the spectra for the hG powder and the composite electrode films. A Bruker D8 Advance System X-ray Diffraction system with a Cu Kα radiation source was used to obtain the diffraction patterns for the LFP powder and dry pressed electrodes. Transmission electron microscopy (TEM) images were acquired using a Hitachi S-5200 field emission microscope. Top-view and cross-sectional scanning electron microscopy (SEM) images of the dry pressed electrodes were completed using a Hitachi SU-70 field-emission SEM microscope in the AIMLab at UMD. The corresponding EDS composition maps were obtained using a Bruker Quantax EDS attached to the Hitachi SU-70 system.

Electrochemical Evaluation

All electrochemical evaluations were completed in CR2032 coin cells. The cells were assembled in an Ar-filled glovebox in a conventional half-cell configuration against lithium (Li) metal, with the electrolyte being 1M lithium hexafluorophosphate (LiPF6) in ethylene carbonate: ethyl methyl carbonate in a 3:7 volume ratio (EC:EMC 3:7). To ensure the complete separation of the high mass-loading cathode and the Li metal, both an ⅝″ glass fiber separator and an ⅝″ Celgard polypropylene separator were used when assembling the cells. Since the composite films are freestanding and thick, rather than using conventional spacers or springs, a ⅝″ (Ni) metal foam cutout was used to maintain sufficient contact between the battery components. All LIB half-cell testing was completed using a VMP3 potentiostat (Bio-Logic). After assembly, all cells rested within the glovebox for at least 12 hours before testing. LIB cells were tested under cycling and rate specific testing conditions in a voltage range of 2.6 to 3.7V using hG:LFP composite cathodes fabricated between 20 and 500 MPa.

The documents listed below and referenced herein are incorporated herein by reference in their entireties, except for any statements contradictory to the express disclosure herein, subject matter disclaimers or disavowals, and except to the extent that the incorporated material is inconsistent with the express disclosure herein, in which case the language in this disclosure controls. Incorporation by reference of the following shall not be considered an admission by the applicant that the incorporated materials are prior art to the present disclosure, nor shall any document be considered material to patentability of the present disclosure.
1. Nitta, N.; Wu, F. X.; Lee, J. T.; Yushin, G., Li-ion battery materials: present and future. Materials Today 2015, 18 (5), 252-264.
2. Dillard, C.; Chung, S. H.; Singh, A.; Manthiram, A.; Kalra, V., Binder-free, freestanding cathodes fabricated with an ultra-rapid diffusion of sulfur into carbon nanofiber mat for lithium-sulfur batteries. Materials Today Energy 2018, 9, 336-344.
3. Cui, L. F.; Hu, L. B.; Choi, J. W.; Cui, Y., Light-Weight Free-Standing Carbon Nanotube-Silicon Films for Anodes of Lithium Ion Batteries. ACS Nano 2010, 4 (7), 3671-3678.
4. Lin, Y.; Han, X. G.; Campbell, C. J.; Kim, J. W.; Zhao, B.; Luo, W.; Dai, J. Q.; Hu, L. B.; Connell, J. W., Holey Graphene Nanomanufacturing: Structure, Composition, and Electrochemical Properties. Advanced Functional Materials 2015, 25 (19), 2920-2927.
5. Ligneel, E.; Lestriez, B.; Richard, O.; Guyomard, D., Optimizing lithium battery performance from a tailor-made processing of the positive composite electrode. Journal of Physics and Chemistry of Solids 2006, 67 (5-6), 1275-1280.
6. Jung, D. S.; Hwang, T. H.; Park, S. B.; Choi, J. W., Spray Drying Method for Large-Scale and High-Performance Silicon Negative Electrodes in Li-Ion Batteries. Nano Letters 2013, 13 (5), 2092-2097.
7. Wood, D. L.; Li, J. L.; Daniel, C., Prospects for reducing the processing cost of lithium ion batteries. Journal of Power Sources 2015, 275, 234-242.
8. Ludwig, B.; Zheng, Z. F.; Shou, W.; Wang, Y.; Pan, H., Solvent-Free Manufacturing of Electrodes for Lithium-ion Batteries. Scientific Reports 2016, 6, 10.
9. Ludwig, B.; Liu, J.; Chen, I. M.; Liu, Y. T.; Shou, W.; Wang, Y.; Pan, H., Understanding Interfacial-Energy-Driven Dry Powder Mixing for Solvent-Free Additive Manufacturing of Li-Ion Battery Electrodes. Advanced Materials Interfaces 2017, 4 (21), 10.
10. Smekens, J.; Gopalakrishnan, R.; Van den Steen, N.; Omar, N.; Hegazy, O.; Hubin, A.; Van Mierlo, J., Influence of Electrode Density on the Performance of Li-Ion Batteries: Experimental and Simulation Results. Energies 2016, 9 (2), 12.
11. Cobb, C. L.; Ho, C. C., Additive Manufacturing: Rethinking Battery Design. Electrochemical Society Interface 2016, 25 (1), 75-78.
12. Ji, J. Y.; Li, Y.; Peng, W. C.; Zhang, G. L.; Zhang, F. B.; Fan, X. B., Advanced Graphene-Based Binder-Free Electrodes for High-Performance Energy Storage. Advanced Materials 2015, 27 (36), 5264-5279.
13. Guerfi, A.; Kaneko, M.; Petitclerc, M.; Mori, M.; Zaghib, K., LiFePO4 water-soluble binder electrode for Li-ion batteries. Journal of Power Sources 2007, 163 (2), 1047-1052.
14. Huang, X. L.; Wang, R. Z.; Xu, D.; Wang, Z. L.; Wang, H. G.; Xu, J. J.; Wu, Z.; Liu, Q. C.; Zhang, Y.; Zhang, X. B., Homogeneous CoO on Graphene for Binder-Free and Ultralong-Life Lithium Ion Batteries. Advanced Functional Materials 2013, 23 (35), 4345-4353.
15. Wenzel, V.; Nirschl, H.; Notzel, D., Challenges in Lithium-Ion-Battery Slurry Preparation and Potential of Modifying Electrode Structures by Different Mixing Processes. Energy Technology 2015, 3 (7), 692-698.
16. Li, J. L.; Daniel, C.; An, S. J.; Wood, D., Evaluation Residual Moisture in Lithium-Ion Battery Electrodes and Its Effect on Electrode Performance. MRS Advances 2016, 1 (15), 1029-1035.
17. Liu, W. W.; Lu, C. X.; Wang, X. L.; Liang, K.; Tay, B. K., In situ fabrication of three-dimensional, ultrathin graphitae/carbon nanotube/NiO composite as binder-free electrode for high-performance energy storage. Journal of Materials Chemistry A 2015, 3 (2), 624-633.
18. Al-Shroofy, M.; Zhang, Q. L.; Xu, J. G.; Chen, T.; Kaur, A. P.; Cheng, Y. T., Solvent-free dry powder coating process for low-cost manufacturing of LiNi1/3Mn1/3Co1/302 cathodes in lithium-ion batteries. Journal of Power Sources 2017, 352, 187-193.
19. Porcher, W.; Lestriez, B.; Jouanneau, S.; Guyomard, D., Design of Aqueous Processed Thick LiFePO4 Composite Electrodes for High-Energy Lithium Battery. Journal of the Electrochemical Society 2009, 156 (3), A133-A144.
20. Porcher, W.; Lestriez, B.; Jouanneau, S.; Guyomard, D., Optimizing the surfactant for the aqueous processing of LiFePO4 composite electrodes. Journal of Power Sources 2010, 195 (9), 2835-2843.
21. Lee, J. H.; Lee, S.; Paik, U.; Choi, Y. M., Aqueous processing of natural graphite particulates for lithium-ion battery anode's and their electrochemical performance. Journal of Power Sources 2005, 147 (1-2), 249-255.
22. Lux, S. F.; Schappacher, F.; Balducci, A.; Passerini, S.; Winter, M., Low Cost, Environmentally Benign Binders for Lithium-Ion Batteries. Journal of the Electrochemical Society 2010, 157 (3), A320-A325.
23. Jeong, S. S.; Bockenfeld, N.; Balducci, A.; Winter, M.; Passerini, S., Natural cellulose as binder for lithium battery electrodes. Journal of Power Sources 2012, 199, 331-335.
24. Jabbour, L.; Gerbaldi, C.; Chaussy, D.; Zeno, E.; Bodoardo, S.; Beneventi, D., Microfibrillated cellulose-graphite nanocomposites for highly flexible paper-like Li-ion battery electrodes. Journal of Materials Chemistry 2010, 20 (35), 7344-7347.
25. Chen, T.; Hu, J. Z.; Zhang, L.; Pan, J.; Liu, Y. Y.; Cheng, Y. T., High performance binder-free SiOx/C composite LIB electrode made of SiOx and lignin. Journal of Power Sources 2017, 362, 236-242.
26. Nirmale, T. C.; Kale, B. B.; Varma, A. J., A review on cellulose and lignin based binders and electrodes: Small steps towards a sustainable lithium ion battery. International Journal of Biological Macromolecules 2017, 103, 1032-1043.
27. Chen, T.; Zhang, Q. L.; Pan, J.; Xu, J. G.; Liu, Y. Y.; Al-Shroofy, M.; Cheng, Y. T., Low-Temperature Treated Lignin as Both Binder and Conductive Additive for Silicon Nanoparticle Composite Electrodes in Lithium-Ion Batteries. ACS Applied Materials & Interfaces 2016, 8 (47), 32341-32348.
28. Cao, K. Z.; Jiao, L. F.; Liu, Y. C.; Liu, H. Q.; Wang, Y. J.; Yuan, H. T., Ultra-High Capacity Lithium-Ion Batteries with Hierarchical CoO Nanowire Clusters as Binder Free Electrodes. Advanced Functional Materials 2015, 25 (7), 1082-1089.
29. Long, H.; Shi, T. L.; Jiang, S. L.; Xi, S.; Chen, R.; Liu, S. Y.; Liao, G. L.; Tang, Z. R., Synthesis of a nanowire self-assembled hierarchical ZnCo2O4 shell/Ni current collector core as binder-free anodes for high-performance Li-ion batteries. Journal of Materials Chemistry A 2014, 2 (11), 3741-3748.
30. Qin, J.; He, C. N.; Zhao, N. Q.; Wang, Z. Y.; Shi, C. S.; Liu, E. Z.; Li, J. J., Graphene Networks Anchored with Sn@Graphene as Lithium Ion Battery Anode. ACS Nano 2014, 8 (2), 1728-1738.
31. Heubner, C.; Liebmann, T.; Voigt, K.; Weiser, M.; Matthey, B.; Junker, N.; Lammel, C.; Schneider, M.; Michaelis, A., Scalable Fabrication of Nanostructured Tin Oxide Anodes for High Energy Lithium-Ion Batteries. ACS Applied Materials & Interfaces 2018, 10 (32), 27019-27029.
32. Luo, S.; Wang, K.; Wang, J. P.; Jiang, K. L.; Li, Q. Q.; Fan, S. S., Binder-Free LiCoO2/Carbon Nanotube Cathodes for High-Performance Lithium Ion Batteries. Advanced Materials 2012, 24 (17), 2294-2298.
33. Ban, C. M.; Wu, Z. C.; Gillaspie, D. T.; Chen, L.; Yan, Y. F.; Blackburn, J. L.; Dillon, A. C., Nanostructured Fe3O4/SWNT Electrode: Binder-Free and High-Rate Li-Ion Anode. Advanced Materials 2010, 22 (20), E145-+.
34. Jia, X. L.; Yan, C. Z.; Chen, Z.; Wang, R. R.; Zhang, Q.; Guo, L.; Wei, F.; Lu, Y. F., Direct growth of flexible LiMn2O4/CNT lithium-ion cathodes. Chemical Communications 2011, 47 (34), 9669-9671.
35. Zhang, H. X.; Feng, C.; Zhai, Y. C.; Jiang, K. L.; Li, Q. Q.; Fan, S. S., Cross-Stacked Carbon Nanotube Sheets Uniformly Loaded with SnO2 Nanoparticles: A Novel Binder-Free and High-Capacity Anode Material for Lithium-Ion Batteries. Advanced Materials 2009, 21 (22), 2299-+.
36. Shen, L. F.; Che, Q.; Li, H. S.; Zhang, X. G., Mesoporous NiCo2O4 Nanowire Arrays Grown on Carbon Textiles as Binder-Free Flexible Electrodes for Energy Storage. Advanced Functional Materials 2014, 24 (18), 2630-2637.
37. Joshi, B. N.; An, S.; Jo, H. S.; Song, K. Y.; Park, H. G.; Hwang, S.; Al-Deyab, S. S.; Yoon, W. Y.; Yoon, S. S., Flexible, Freestanding, and Binder-free SnOx-ZnO/Carbon Nanofiber Composites for Lithium Ion Battery Anodes. ACS Applied Materials & Interfaces 2016, 8 (14), 9446-9453.
38. Zhu, X. L.; Zhang, P.; Xu, S.; Yan, X. B.; Xue, Q. J., Free-Standing Three-Dimensional Graphene/Manganese Oxide Hybrids As Binder-Free Electrode Materials for Energy Storage Applications. ACS Applied Materials & Interfaces 2014, 6 (14), 11665-11674.
39. Toprakci, O.; Toprakci, H. A. K.; Ji, L. W.; Xu, G. J.; Lin, Z.; Zhang, X. W., Carbon Nanotube-Loaded Electrospun LiFePO4/Carbon Composite Nanofibers As Stable and Binder-Free Cathodes for Rechargeable Lithium-Ion Batteries. ACS Applied Materials & Interfaces 2012, 4 (3), 1273-1280.
40. Fei, L.; Yoo, S. H.; Villamayor, R. A. R.; Williams, B. P.; Gong, S. Y.; Park, S.; Shin, K.; Joo, Y. L., Graphene Oxide Involved Air-Controlled Electrospray for Uniform, Fast, Instantly Dry, and Binder-Free Electrode Fabrication. ACS Applied Materials & Interfaces 2017, 9 (11), 9738-9746.
41. Hu, T.; Xin, G. Q.; Sun, H. T.; Sun, X.; Yu, M. P.; Liu, C. S.; Lian, J., Electrospray deposition of a Co3O4 nanoparticles-graphene composite for a binder-free lithium ion battery electrode. RSC Advances 2014, 4 (4), 1521-1525.
42. Miao, Y. E.; Huang, Y. P.; Zhang, L. S.; Fan, W.; Lai, F. L.; Liu, T. X., Electrospun porous carbon nanofiber@MoS2 core/sheath fiber membranes as highly flexible and binder-free anodes for lithium-ion batteries. Nanoscale 2015, 7 (25), 11093-11101.
43. Xie, W. H.; Li, S. Y.; Wang, S. Y.; Xue, S.; Liu, Z. J.; Jiang, X. Y.; He, D. Y., N-Doped Amorphous Carbon Coated Fe3O4/SnO2 Coaxial Nanofibers as a Binder-Free Self-Supported Electrode for Lithium Ion Batteries. ACS Applied Materials & Interfaces 2014, 6 (22), 20334-20339.
44. Han, X. G.; Funk, M. R.; Shen, F.; Chen, Y. C.; Li, Y. Y.; Campbell, C. J.; Dai, J. Q.; Yang, X. F.; Kim, J. W.; Liao, Y. L.; Connell, J. W.; Barone, V.; Chen, Z. F.; Lin, Y.; Hu, L. B., Scalable Holey Graphene Synthesis and Dense Electrode Fabrication toward High-Performance Ultracapacitors. ACS Nano 2014, 8 (8), 8255-8265.
45. Han, X. G.; Yang, Z.; Zhao, B.; Zhu, S. Z.; Zhou, L. H.; Dai, J. Q.; Kim, J. W.; Liu, B. Y.; Connell, J. W.; Li, T.; Yang, B.; Lin, Y.; Hu, L. B., Compressible, Dense, Three-Dimensional Holey Graphene Monolithic Architecture. Acs Nano 2017, 11 (3), 3189-3197.
46. Walsh, E. D.; Han, X. G.; Lacey, S. D.; Kim, J. W.; Connell, J. W.; Hu, L. B.; Lin, Y., Dry-Processed, Binder-Free Holey Graphene Electrodes for Supercapacitors with Ultrahigh Areal Loadings. ACS Applied Materials & Interfaces 2016, 8 (43), 29478-29485.
47. Lin, Y.; Moitoso, B.; Martinez-Martinez, C.; Walsh, E. D.; Lacey, S. D.; Kim, J. W.; Dai, L. M.; Hu, L. B.; Connell, J. W., Ultrahigh-Capacity Lithium-Oxygen Batteries Enabled by Dry-Pressed Holey Graphene Air Cathodes. Nano Letters 2017, 17 (5), 3252-3260.
48. Lacey, S. D.; Walsh, E. D.; Hitz, E.; Dai, J. Q.; Connell, J. W.; Hu, L. B.; Lin, Y., Highly compressible, binderless and ultrathick holey graphene-based electrode architectures. Nano Energy 2017, 31, 386-392.
49. Yamada, A.; Chung, S. C.; Hinokuma, K., Optimized LiFePO4 for lithium battery cathodes. Journal of the Electrochemical Society 2001, 148 (3), A224-A229.
50. Yamada, A.; Koizumi, H.; Sonoyama, N.; Kanno, R., Phase change in LixFePO4. Electrochemical and Solid State Letters 2005, 8 (8), A409-A413.
51. Padhi, A. K.; Nanjundaswamy, K. S.; Goodenough, J. B., Phospho-olivines as positive-electrode materials for rechargeable lithium batteries. Journal of the Electrochemical Society 1997, 144 (4), 1188-1194.

1. A method for manufacturing a composite electrode, comprising:
providing a compressible carbon allotrope and at least one active material/powder of a battery, and
dry compressing the compressible carbon allotrope and the at least one active material without using a binder or a solvent.

2-3. (canceled)

4. The method of claim 1, wherein the active material/powder is an intercalation/insertion compound, a conversion compound, or a material that undergoes surface-based reactions.

5. (canceled)

6. The method of claim 1, wherein the dry compressing is operated under a pressure ranging from 20 MPa to 500 MPa.

7. The method of claim 1, wherein the composite electrode is formed on a substrate or as a freestanding structure.

8-11. (canceled)

12. The method of claim 1, wherein the dry compressing is operated at room temperature.

13. The method of claim 1, wherein the pressure is applied through a compression system selected from hydraulics and pneumatics.

14. The method of claim 6, wherein pressure is applied for a period ranging from 1 second to 1 hour.

15. The method of claim 1, further comprising the step of subsequent removing of at least one substrate to form a supported or freestanding composite electrode.

16. The method of claim 1, further comprising the step of mixing or laying compressible carbon allotrope and the at least one active material before the step of dry compressing.

17. A composite material comprising:
a compressible carbon allotrope, and
at least one active material,
wherein the composite material is manufactured by a dry compression process.

18. The composite material of claim 17, wherein the composite material is formed without the use of a binder or a solvent.

19. The composite material of claim 17, wherein the at least one active material is an active battery powder.

20. (canceled)

21. The composite material of claim 17, wherein the at least one active material is an intercalation/insertion compound, a conversion compound, or a material that undergoes surface-based reactions.

22. (canceled)

23. The composite material of claim 17, wherein the dry compression process is operated under a pressure ranging from 20 MPa to 500 MPa.

24. The composite material of claim 17, wherein the composite material is formed on a substrate or as a freestanding structure.

25-26. (canceled)

27. The composite material of claim 17, wherein the composite material is formed with a carbon-rich or an active material-rich composition.

28. The composite material of claim 17, wherein the dry compression process is operated at room temperature.

29. The composite material of claim 23, wherein the pressure is applied through a compression system selected from hydraulics and pneumatics.

30. The composite material of claim 24, wherein the pressure is applied for a period ranging from 1 second to 1 hour.

31. An energy storage device comprising the composite material of claim 17.

32. (canceled)
